(19) United States
(12) Patent Application Publication
(10) Pub. No.: US 2005/0050101 A1
(43) Pub. Date: Mar. 3, 2005

(54) Identification and use of informative sequences

(76) Inventors: Joseph G. Vockley, Damascus, MD (US); Gregory D. Eley, Springfield, VA (US)

Correspondence Address: KILPATRICK STOCKTON LLP, 607 14TH STREET, N.W., WASHINGTON, DC, 20005, US

(21) Appl. No.: 10/762,763

(22) Filed: Jan. 23, 2004

Related U.S. Application Data
(60) Provisional application No. 60/441,745, filed on Jan. 23, 2003.
(60) Provisional application No. 60/441,806, filed on Jan. 23, 2003.

(51) Int. Cl. G06F 7/00

(52) U.S. Cl. 707/104.1

(57) ABSTRACT

Identifying genomic sequences and oligonucleotide sequences unique to a set of organisms. Methods include obtaining genomic data characteristic of the set; formatting the data into at least one query-length sequence, each query-length sequence being of a format compatible with a similarity search engine. Searching a selected genomic database using the query and the similarity search engine. Then parsing the results of the search for those sequences showing uniqueness to the set.

### CROSS REFERENCE TO RELATED APPLICATIONS

The present application claims the priority benefit of pending U.S. Provisional Patent Application No. 60/441,745 filed Jan. 23, 2003 and pending U.S. Provisional Patent Application No. 60/441,806 filed Jan. 23, 2003. The complete disclosure of both applications is hereby incorporated herein by reference. The present application also hereby incorporates herein by reference the entire disclosure of pending utility patent application 10/______, titled Method and System for Identifying Biological Entities in Biological and Environmental Samples, filed Jan. 23, 2004.

### STATEMENT REGARDING FEDERALLY SPONSORED RESEARCH OR DEVELOPMENT

Embodiments of the invention may have been conceived or first actually reduced to practice in the performance of work under the following Government contracts:______. As a result, the Government may have certain rights in those inventions.

### BACKGROUND

1. Field of the Invention

Embodiments of the invention relate to the identification of genomic sequences that are informative of the biological characteristics (e.g., presence, abundance, virulence, genetic modification) of a sample, along with systems and methods of using such sequences for gathering information on one or more sets of organisms present in the sample. Specific embodiments relate to microbial organisms.

2. Description of Related Art

Genes, natural units of hereditary material, are the physical basis for the transmission of the characteristics of biological entities from one generation to another. The basic genetic material is fundamentally the same in all biological entities. It consists of chain-like molecules of nucleic acids (deoxyribonucleic acid (DNA) in most organisms and ribonucleic acid (RNA) in certain viruses) and is usually associated in a linear or circular arrangement that, in part, constitutes chromosomes and extra-chromosomal elements, such as micro-chromosomal bodies. The entire hereditary material in a cell is called the “genome.” In addition to the DNA contained in the nucleus, an organism's cells contain DNA in other locations within those cells, e.g., bacteria also contain some DNA in plasmids, plants also contain some DNA in plastids, animals also contain some DNA in mitochondria. A set of biological entities, such as a species, has a genome, e.g., the complete sequence of genes characteristic of the set. Some portions of the genome are unique to the particular set, e.g., set-unique sequences. Example sets include strain, species, genus, family, group, lade, and other ad hoc sets.

Historically, the theory, principles, and process of classifying biological entities into sets (e.g.,, taxonomic classification) is based on the work of seventeenth century biologist Carl Linnaeus. Linnaeus created the taxonomy system of kingdom, phylum, class, order, family, genus, and species. Known as the Linnean system, this rank-based taxonomy is still in use today. Other basis for classifying organisms have been proposed, including some based on phylogeny, i.e., the evolutionary development of biological entities. For example, in contrast to the rank-based codes, the PhyloCode will provide rules for the express purpose of naming clades and species through explicit reference to phylogeny. See e.g., http://www.ohiou.edu/phylocode/index.html, accessed Jan. 14, 2004.

As noted by the National Center for Biotechnology Information (NCBI) at htpp://www.ncbi.nlm.nih.gov/BLAST/blast_overview.shtml (accessed Jan. 5, 2004), BLAST® (Basic Local Alignment Search Tool) is a set of similarity search programs designed to explore genetic sequence databases available through NCBI. The BLAST programs have been designed for speed, with a minimal sacrifice of sensitivity to distant sequence relationships. The scores assigned in a BLAST search have a well-defined statistical interpretation, making real matches easier to distinguish from random background hits. BLAST uses a heuristic algorithm that seeks local as opposed to global alignments and is therefore able to detect relationships among sequences that share only isolated regions of similarity. The Expected Value (“E”) as noted in BLAST search results is a parameter that describes the number of hits of the type shown that one can expect to see just by chance when searching a database of a particular size. It decreases exponentially with the Score (“S”) that is assigned to a match between two sequences. E can be interpreted as the random background noise that exists for matches between sequences. For example, an E value of 1 assigned to a hit can be interpreted as meaning that in a database of the current size, one might expect to see one match with a similar score simply by chance. This can be interpreted to means that the lower the E-value, or the closer it is to “0”, the more significant the match is.

### SUMMARY OF THE INVENTION

Embodiments of the invention include systems and methods to identify of genomic sequences that are informative of the biological characteristics (e.g., presence, abundance, virulence, genetic modification) of a sample, along with systems and methods of using such sequences for gathering information on one or more sets of organisms present in the sample. Specific embodiments relate to microbial organisms.

A method for identifying genomic sequences unique to a set of organisms includes obtaining genomic data characteristic of the set. The sequences are formatted into query-length sequences; each query-length sequence being of a format compatible with a similarity search engine such as BLAST. A selected genomic database, such as those maintained by NCBI (or a more restricted database) is searched using the query and the similarity search engine. The results of the search are parsed for those sequences showing uniqueness to the set.

The invention includes computer programs for identifying genomic sequences unique to a set of organisms. These programs can be carried one or more computer-readable media and include a genomic data interface module. The genomic data interface module is operable to couple to a source of genomic data to receive genomic data characteristic of the set. A formatting module formats the received genomic data into query-length sequences, where each query-length sequence is formatted compatible with a similarity search engine such as BLAST. A search interface module interfaces with the similarity search engine to submit the query-length sequence to the search engine. A search results parsing module parses the results of the search for those sequences showing uniqueness to the set.

Embodiments of the invention include methods for identifying oligonucleotide sequences unique to a set of organisms. In those methods, after identifying unique genomic sequences (typically, but not necessarily, as described above), unique genomic sequences are divided into target-length oligonucleotide sequences; preferable a number of sequences starting with the beginning of the genomic sequence and progressing one nucleotide at a time. The oligonucleotide sequences are properly formatted and searched to a selected database using a similarity search engine such as BLAST. The results are parsed for those oligonucleotides showing uniqueness to the set. A computer program product can implement this method in modules similar to those above.

The invention includes methods for inferring both unique genomic sequences and unique oligonucleotide sequences. In those methods, genomic data characteristic of a first set of organisms is obtained. The data is formatted into at least one query-length sequence, each query-length sequence being of a format compatible with a similarity search engine. A selected genomic database, e.g., an NCBI database, is searched using the query and the similarity search engine such as BLAST. The results are parsed for those sequences not associated with the first set of organisms, but showing similarity beyond a threshold.

### BRIEF DESCRIPTION OF THE DRAWINGS

FIG. 1 is a flowchart describing, in conjunction with portions of the written description, methods of the present invention.

FIG. 2 is a notional illustration of a target oligonucleotide window in the context of a unique genomic sequence of the present invention.

FIG. 3 is a notional illustration of differential hybridization of several unique oligonucleotides of the present invention between two strains of E. coli.

FIG. 4 is an illustration of a decision tree of the present invention.

### DETAILED DESCRIPTION OF THE INVENTION

As required, detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

For purposes of the invention disclosure, the term “primer” includes a short pre-existing polynucleotide chain to which new nucleotides can be added by DNA or RNA polymerase.

The term “randomly amplifying” includes increasing the copy number of a segment of nucleic acid in vitro using random primers.

“Amplicon” refers to DNA that has been manufactured utilizing a polymerase chain reaction (PCR) where a set of single stranded primers is used to direct the amplification of a single species of DNA.

“Biological entity” describes a biological element, cellular component, or organism that exists as a particular and discrete unit. This includes, but is not limited to gene, transgene, oncogene, allele, protein, DNA, RNA, mitochondria, pathogenic trait, vector, plasmid, clone, Acytota, prokaryotes, eukaryotes, Protista, Fungi, Plantae, Animalia and Monera, or any mixture thereof. For simplicity, “organism” is used interchangeably herein with “biological entity,” and includes sub-organism entities. “Set of organisms” includes sets of one biological entity.

A “sample” may be from any source, and can be a gas, a fluid, a solid, a biological sample, an environmental sample, or any mixture thereof.

“Nucleic acids” means RNA and/or DNA, and may include unnatural bases.

The “unique oligonucleotide sequence” generally identifies a nucleic acid sequence for which the sequence is known and determined unique to a set of organisms. In some embodiments, unique oligonucleotide sequences are more than 30 nucleotides in length.

The terms “unique genomic sequence” and “unique sequence” are interchangeable in the invention and refer generally to a sequence of nucleic acids that are specific to a set of organisms.

In the literature there exist at least two confusing nomenclature systems for referring to hybridization partners. Both use common terms: “probes” and “targets.” For the purpose of this disclosure, a “target” is the known oligonucleotide sequence (preferably set-unique), whereas a “probe” is the nucleic acid sample whose characteristic(s) (e.g., identity, abundance, virulence) is being detected. “Probe” includes any single stranded nucleic acid sequence, molecule, genomic sequence, or amplicon which typically is labeled. Probes can hybridize to a target if sufficient complementarities exist. Note that labeling can be implemented at various stages in either the probe or target or both, as known to those skilled in the art.

The terms “microarray” and “array” are interchangeable and include a set of miniaturized chemical or biological reaction areas that may also be used to test DNA, DNA fragments, RNA, antibodies, or proteins.

A “labeled” or “detectable” nucleic acid is a nucleic acid that can be detected. The term “detection” refers to a method where analysis or viewing of the detectable nucleic acid is possible visually or with the aid of a device, including, but not limited to microscopes, fluorescent activated cell sorter (FACS) devices, spectrophotometers, scintillation counters, and fluorometers, devices using mass spectrometry, devices using radio isotopes.

“Hybridized” means having formed a sufficient number of base pairs to form a nucleic acid that is at least partly double-stranded under the conditions of detection. The term “hybridization” refers to the process by which two complementary strands of nucleic acids combine to form double-stranded molecules.

The term “complementarity” refers to a property conferred by the base sequence of a single strand of DNA or RNA that may form a hybrid or double stranded DNA:DNA, RNA:RNA or DNA:RNA through hydrogen bonding between base pairs on the respective strands. Adenine (A) usually complements thymine (T) or uracil (U), while guanine (G) usually complements cytosine (C).

The identification and characterization of microorganisms present in the environment has historically been accomplished by exploiting a variety of biological, immunological, biochemical, and genetic differences between organisms. Nucleic acid-based diagnostic methods have been developed that are specific for a single organism or small sets of organisms. PCR-based assays are typically performed by designing oligonucleotide primers that amplify organism-specific fragments of DNA. These fragments are subsequently detected by methods such as gel-electrophoresis, real-time PCR, or hybridization to either a membrane or microarray. A limitation of these existing assays is that although a positive result is informative for a specific organism or organism set, a negative result typically provides little or no information about the organism(s) under investigation.

Though it is possible to multiplex primers for numerous amplifications in a PCR for the concurrent identification of a variety of organisms, it is non-trivial to design compatible multiple primer pair sets that function in a single amplification reaction. Thus, the number of microorganisms that can be detected or otherwise characterized concurrently with this type of multiplex reaction is relatively small. Techniques such as real-time PCR and quantitative PCR are limited in the number of primer sets that can be used in a single amplification reaction and in the number of fluorescent molecules available for labeling DNA molecules and detection.

In a method for detecting and distinguishing between various species and strains of viruses, viral RNA is reverse transcribed from semi-random primers, amplified by specific primers and then labeled with fluorescent nucleotides in a non-amplifying reaction. The labeled nucleic acids are then hybridized to microarrays that have been spotted with virus and strain-specific oligonucleotides that represent the entire genomes of these organisms. The resulting hybridization pattern discriminates between viruses represented on the array. However this approach is not directly translatable to fungi and bacteria. The relatively large size (3-5 million bases) and complexity of bacterial and fungal genomes, as compared to most viral genomes, represents an obstacle in the ability to identify oligonucleotides that are species and strain specific. In addition, it is not feasible to synthesize and spot every possible oligonucleotide for every microbial genome onto a microarray.

Bioinformatic tools such as BLAST, are intended to identify similarities between sequences. While similarities between the sequences of organisms are useful in some types of analysis, the differences between genomes can be useful in the identification and characterization of microorganisms. Unfortunately, bacterial and fungal genomes are so large that it is resource-intensive to subtract common sequences in order to identify unique sequences from all known genomes. Frequently only small fragments of genomic sequences have been identified as unique are available for identification of an organism. The increasing number of genomes that have been, or will soon be, sequenced is one incentive for identifying large fragments of known genomes.

Current nucleotide-based methods of identifying organisms typically rely on primer-requiring multiples PCR methods, or oligonucleotide microarrays that utilize the limited amount of ribosomal genes (approximately 1% of the genome), or costly shotgun approaches directed at entire genomes. Ribosomal DNA is highly conserved across higher level sets—therefore the amount of unique sequence is limited.

Approximately 300 microbial genomes have been partially or completely sequenced to date. In spite of this wealth of information, existing methods of detection and characterization of microbes are limited by the availability of unique sequence information from the genomes of these organisms. Typically, only small fragments of genomic sequences are identified as unique.

Current DNA amplification approaches to identify microorganisms are limited in terms of the number of sequences that can be identified concurrently. In vitro, two methods are used to multiplex, or identify multiple sequences concurrently. Both are limited by the challenge of generating specific primer pair sets that work well together in a single reaction mixture. One method for assessing which amplicons are produced in a multiplex PCR is to run the amplification product on a gel and to discriminate the various amplicons based on molecular size. The number of size indicative bands that can be resolved on the gel is a limiting factor for this approach.

Another method, real time PCR, uses different fluorescent tags to identify specific amplicons in a multiplex PCR. The number of amplicons that can be resolved using this approach is limited by the number of different fluorescent tags available for probes used in the reaction. Current limitations for fluorescent resonance energy transfer methods, such a Taqman and molecular beacons are about four amplicons for a single reaction. Thus the limitations are at least two-fold: the first is a compatibility issue regarding the use of multiple sets of unique primers; and the second is resolution of the amplified products.

Unique genomic sequences in a set of organisms (which set can consist of one or more biological entities) may include both coding and non-coding sequences. Coding sequences are sequences that are further processed into proteins or polypeptides, typically performing a single function. These sequences are frequently conserved across genus and species. Conserved coding sequences can include genes that code for enzymatic elements, structural elements, virulence factors or developmental specific functions and processes.

Non-coding sequences are sequences that are not further processed and do not appear to possess a known function at this time. These sequences may be contained in a portion of the genome that contains unique coding sequences as well as between conserved coding sequences. Since non-coding sequences do not provide a known function, they are frequently overlooked as unimportant genomic material. These unique non-coding sequences can be used to identify an organism, just as unique coding sequences are used. Informative sequences can reflect a variety of features e.g. structural, functional, metabolic, virulence. Set-unique sequences can be coding or non-coding sequences. Set-unique sequences (coding or non-coding) can be inferred (see below) or found by searching through fully sequenced genomes. Partially sequenced genomes typically focus on coding sequences. Combinations of sequences that are not necessarily individually set-unique can also be informative. Sequences unique to sets above the species or strain level can be bio-informative, e.g., used in analyzing a sample for information about the organisms in the sample as described below.

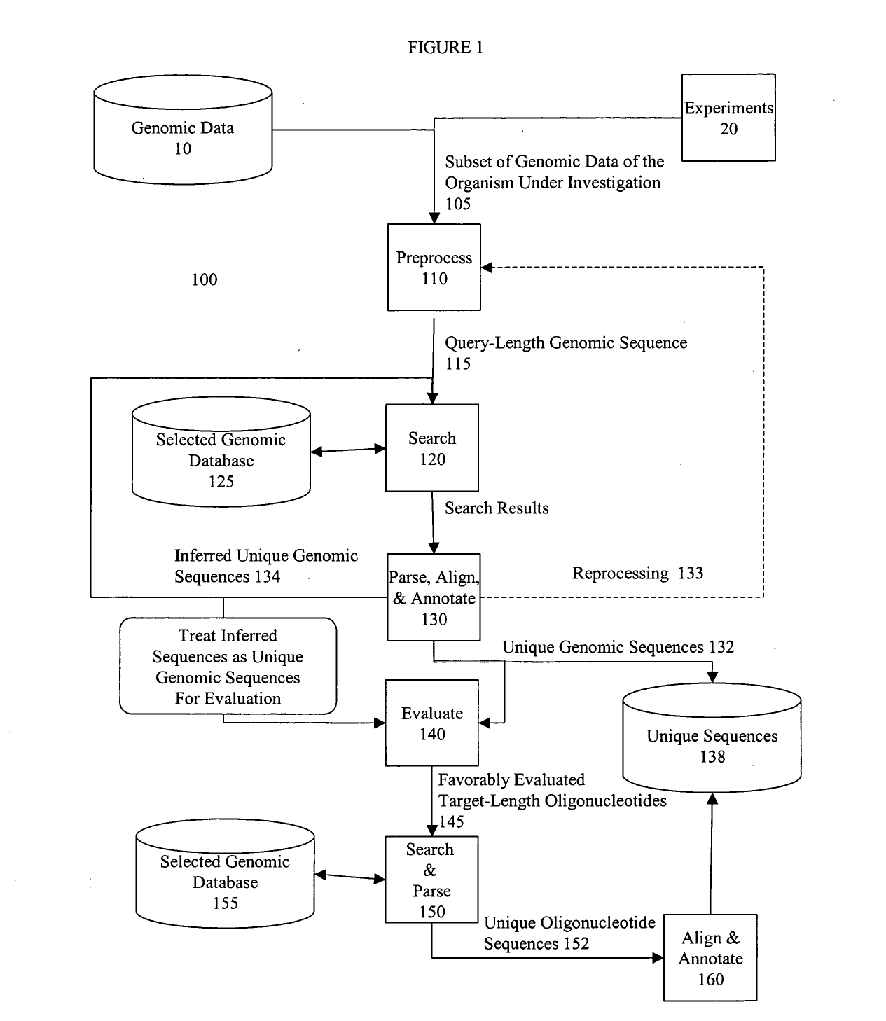

Embodiments of the present invention include methods and systems for the identification of genomic sequences that are informative of the biological characteristics (e.g., presence, abundance, virulence, genetic modification) of a sample. Referring to FIG. 1, a illustrative method 100 of the present invention is shown.

In the illustrated embodiment, a subset of the genomic data 105 of the organism under investigation is obtained. The subset 105 can be obtained from known genomic data source 10, e.g., UniGene, GenBank, European Molecular Biological Laboratory (EMBL), among other sources. Genomic data can also be obtained as sequence derived from in vivo or in vitro experiments 20 such as PCR and enzymatic digestion. A preferred subset of genomic data is the entire genomic sequence of an organism.

In some embodiments, the obtained genomic data is preprocessed 110. Each aspect of preprocessing can be performed as needed or desired.

In preferred embodiments, if necessary, the genomic data subset is converted from its native format, e.g., standard GenBank annotated format, to a format compatible with subsequent steps. In some embodiments, where GenBank annotated form at is used, the genomic data is converted to FASTA format to support a subsequent BLAST search.

Preprocessing can involve removing or masking portions of the genomic data that are judged not likely to have informative value. In preferred embodiments, these portions are removed, partly to make the subsequent search more efficient. This can include sequences known to be conserved with respect to the organism set under investigation (though some conserved sequences can be bioinformative, and sequences conserved at one tier in a taxonomy may be unique in another tier), repeats, inverted repeats, long terminal repeats, sequences otherwise known to be not favorable for hybridization.

In preferred embodiments, genomic data is divided into query-length sequences 115. Some embodiments start with sequences of 1000 bases in length. The speed of the search is one factor in selecting the size of the initial query sequence. Subsequent iterations, described below, divide the initial query length further.

In further preprocessing, query-length genomic sequences were realigned with the genome from which they were generated in order to determine the start and stop point of each query length sequence within the genome. Any annotations within the genome in the region containing the query length genomic sequence were transferred to the query length genomic sequence. Annotated regions include sequences known to have a specific biological function such as protein coding regions, biologically active RNA encoding regions, promoter and regulatory elements, spacing elements within operons, protein binding sites, and the like.

Note that if an entire genome was obtained, and no preprocessing performed, the query-length sequence 115 is the entire genome of the organism under investigation. In some embodiments, all the genomic data available for the organism under investigation is obtained, all preprocessing steps are completed, resulting in annotated query-length sequences of 1000 bases that do not include conserved sequences, repeats of various types, or sequences having characteristics that otherwise make them not amenable to subsequent steps.

In preferred embodiments, the query length sequence (preprocessed or not) is used as a query to a similarity search program 120, e.g., BLAST. The query is directed to a selected database 125 of genome data. In some embodiments, the selected database is limited to organisms of the same general type as that under question, in order to increase search efficiency over what it would be were the search directed to a full database containing a broader variety of organisms. In some embodiments, the query is directed to the NCBI nr database. For example, if only microbial organisms were under investigation, the selected database 125 would be a database of microbial genomic data—broader databases including, for example, mammalian genomic data, would be avoided at this stage. In these circumstances, a subsequent search against the broader database is preferred in order to confirm the set-uniqueness of these initial results. In some embodiments, query-length sequence is removed from the selected database, while in other embodiments, results showing homology to the query itself are either ignored, or taken as confirmation of the validity of the query with respect to the organism under investigation. Table 1 lists an exemplary query for a strain of Escherichia coli.

TABLE 1

>NC_000913_29part354 Escherichia coli K12, complete genome.
TATGTTTTAAATAACTAATTGGTCGGGTTAGTGCATCCGGCTTTCTTTATATTCGCCAGA
AGGATTTATTATGCAAAGGAAAACTCTATTGTCGGCCTGTATTGCATTAGCTCTGAGTGG
TCAGGGTTGGGCGGCAGATATCACAGAGGTAGAAACCACCACAGGTGAAAAGAAAAATAC
CAATGTGACTTGTCCGGCAGACCCAGGAAAACTCAGTCCGGAAGAGCTTAAACGCTTACC
CTCTGAATGCTCTCCTTTAGTCGAACAAAACCTGATGCCATGGCTTTCCACAGGCGCTGC
TGCGTTAATCACGGCCTTAGCCGTAGTGGAACTAAACGACGATGATGATCATCATCATCG
CAACAATTCTCCACTCCCACCGACACCCCCTGATGATGAATCAGACGACACTCCAGTTCC
CCCAACTCCTGGCGGAGATGAGATAATACCGGACGATCCGGATGATACGCCTACACCTCC
CAAACCGGTTTCGTTTAATAATGACGTTATTCTCGATAAAACAGAAAAAACGTTAACTATT
CGCGATTCAGTTTTTACTTATACCGAGAATGCTGACGGGACTATATCTCTGCAAGATAGCA
ATGGTCGTAAGGCAACGATTAATCTTTGGCAGATTGATGAAGCGAATAACACTGTTGCCCT
TGAAGGGGTGAGCGCAGATGGCGCAACGAAGTGGCAATATAATCACAACGGTGAGCTTGTT
ATTACGGGTGATAATGCCACAGTAAACAACAATGGCAAAACCACCGTTGACGGTAAAGATT
CCACCGGTACGGAAATCAACGGTAATAACGGGAAAGTGATTCAGGACGGCGATCTGGATGT
CAGCGGCGGCGGTCACGGTATTGATATCACCGGTGACAGCGCGACGGTGGATAACAAGGGC
ACCATGACCGTCACCGATCCGGAGTCCATGGGTATCCAGATCGACGGTGACAAGGCCATCGT
CAATAACGAAGGCGAGAGCACCATCACCAAC

Preferred embodiments parse 130 the similarity search program output 125 to identify sequences lacking significant similarity with other organisms in the selected database, e.g., unique genomic sequences 132. This is counter to the typical use of such search programs. For the purpose of this disclosure, “unique” or “uniqueness” is a function of thresholds, preferably controlled by the user, regarding identity, homology, score, expected (E) value and the length of the unique sequence under consideration. Identity, score, expected value are data returned in a typical BLAST search. In some embodiments, lacking significant similarity, e.g., “unique,” means no BLAST hits or hits with a E-value less than 1e−5.

In practice, computational resources are finite, so the selected database may range from a database of all fully or partially known genomes to a narrower database such as known microbial genomes. Directing the initial query to a database of less than all available genome data, while computationally economical, can make it advisable to BLAST the candidate sequences (e.g., in preferred embodiments, those genetic sequence segments found to be unique) against the broader databases, e.g., the NCBI nr database, to detect homology with known genomes.

Table 2 is an extract from an exemplary BLAST output for the sequence in Table 1. Note that significant alignments with E values less that 1e47 are all E. coli. This confirms that the query sequence is sufficiently “unique” with respect to E. coli to be informative.

TABLE 2

BLASTN 2.2.7 [Jan-02-2004]
RID: 1074618061-23468-21421924927.BLASTQ4
Query = (1000 letters)
Database: All GenBank + EMBL + DDBJ + PDB sequences (but no EST, STS,
GSS, or phase 0, 1 or 2 HTGS sequences) 2,017,250 sequences; 9,771,119,756
total letters
Distribution of 64 Blast Hits on the Query Sequence

| | Score | E |
|---|---|---|
| Sequences producing significant alignments: | bits) | Value |
| gi\|1787665\|gb\|AE000237.1\|AE000237 Escherichia coli K12 MG16 . . . | 1982 | 0.0 |
| gi\|1742273\|dbj\|D90778.1\| E. coli genomic DNA, Kohara clone # . . . | 1982 | 0.0 |
| gi\|26107941\|gb\|AE016760.1\| Escherichia coli CFT073 section . . . | 1191 | 0.0 |
| gi\|41829\|emb\|X62680.1\|ECIS2IS30 E. coli insertion sequences . . . | 198 | 1e−47 |
| gi\|24431548\|gb\|AC125613.2\| Homo sapiens 3 BAC RP11-379M20 ( . . . | 44 | 0.50 |
| gi\|18159853\|gb\|AE009803.1\|AE009803 Pyrobaculum aerophilum s . . . | 42 | 2.0 |
| gi\|6067150\|gb\|AC008015.5\|AC008015 Homo sapiens chromosome 1 . . . | 42 | 2.0 |
| gi\|21644686\|dbj\|AP004363.3\| Oryza sativa (japonica cultivar . . . | 42 | 2.0 |
| gi\|10862756\|emb\|AL354852.12\| Human DNA sequence from clone . . . | 42 | 2.0 |

At this point, those sequences (less than or equal to query-length) that show homology/identity with other organisms below a threshold can be identified as unique to the set for which they were searched. Such sequences have utility to confirm the presence of at least one member of the set, primarily, but not exclusively in a Bioinformatic setting. Sequences unique to higher level sets are identified by searching for commonalities between sequences within a classification. These common sequences are then searched against the appropriate database. Such sequences, with optional annotation, can be realigned with the genomic data, annotated with the information gained saved to a database of unique genomic sequences 132, or added to the growing knowledge base of the genome of the organism under investigation.

In some embodiments, where a certain minimum number of total unique bases, e.g., 10,000, is desired across all unique genomic sequences, and less than this number are determined to be unique, the genomic data can be preprocessed again, this time dividing the genomic data into smaller query-length sequences. The smaller query length sequences are then searched against the target database. Control line 133 indicates this path.

The output of the similarity search program can also be used to identify further query-length sequences or candidate sequences for organism(s) other than the organism(s) under investigation. For example a first query-length sequence may show high homology/identity only against the particular strain it was derived from. But the query sequence might also show some homology to a related strain. Such sequences can be referred to as inferred sequences 134. The portion of the related strain where limited homology is detected can be searched 120 as a query-length genomic sequence 115 (by being searched against the selected database 125) to confirm its identity as a unique genomic sequence 132 for the related organism(s); or it can be treated as a candidate sequence for evaluation (discussed below) where target-length oligonucleotides are evaluated for amenability to hybridization. Exemplary inferred sequences have sufficient homology to the related sequence to be indicated by a BLAST search, but not sufficient to cross-hybridize with oligonucleotides derived from the related sequence.

Referring to Table 3, a search against the NCBI nr database, using as a query a Vaccinia sequence found to be unique by a method of the present invention, identified two candidate sequences A01, A02 (a Vaccina strain and the complete Vaccinia genome) with 100% identity over the entire query sequence; five non-Vaccinia sequences A03-A07 with identity ranging from 96% to 92% over portions of the query sequence; one non-Vaccinia sequence A08 with 100 identity over a small portions of the query sequence; and at least seven non-microbial sequences A09-A15 with E values greater than three for short portions of the query sequence.

The first group confirms that the query sequence is part of both the Vaccinia strain and complete genome. The second and third groups identify sets of organisms with significant homology, e.g., E value less than 1e−5, to the set-unique Vaccinia sequence. Preferred embodiments of the invention infer that the second and third group of sequences come from unique regions of the genome of those organism sets. Such inferred sequences preferably undergo evaluation and validation as described herein.

TABLE 3

BLASTN 2.2.4; RID: 1036169670-05727-22152
Query = (160 letters)
Database: All GenBank + EMBL + DDBJ + PDB sequences
(but no EST, STS, GSS, or phase 0, 1 or 2 HTGS sequences)
1,430,422 sequences; 7,041,770,514 total letters
Distribution of 19 BLAST Hits on the Query Sequence

| | Score | E |
|---|---|---|
| Sequences producing significant alignments: | (bits) | Value |
| gi\|2772662\|gb\|U94848.1\|U94848 Vaccinia virus strain Ankara, . . . | 317 | 2e−84 |
| gi\|335317\|gb\|M35027.1\|VACCG Vaccinia virus, complete genome | 317 | 2e−84 |
| gi\|3096962\|emb\|Y11842.1\|CVGRI90 Cowpox virus strain GRI-90 | 270 | 5e−70 |
| gi\|3097015\|emb\|Y15035.1\|CVY15035 Cowpox virus strain GRI-90 . . . | 270 | 5e−70 |
| gi\|20152989\|gb\|AF482758.1\| Cowpox virus strain Brighton Red . . . | 252 | 1e−64 |
| gi\|18482913\|gb\|AF438165.1\| Camelpox virus M-96 from Kazakhs . . . | 228 | 2e−57 |
| gi\|19717929\|gb\|AY009089.1\| Camelpox virus CMS, complete genome | 220 | 4e−55 |
| gi\|22123748\|gb\|AF012825.2\| Ectromelia virus strain Moscow, . . . | 80 | 9e−13 |
| gi\|14574206\|gb\|U23449.2\| Caenorhabditis elegans cosmid K06A . . . | 38 | 3.2 |
| gi\|687828\|gb\|U21318.1\| Caenorhabditis elegans cosmid K03H9, . . . | 38 | 3.2 |
| gi\|12000447\|gb\|AC084754.14\| Homo sapiens 12p BAC RP11-874G1 . . . | 38 | 3.2 |
| gi\|17534934\|ref\|NM_062895.1\| Cuticulin precursor | 38 | 3.2 |
| gi\|18250549\|emb\|AL627429.8\| Human DNA sequence from clone R . . . | 38 | 3.2 |
| gi\|16973060\|emb\|AL590101.9\| Human DNA sequence from clone R . . . | 38 | 3.2 |
| gi\|23337297\|emb\|AL732317.13\| Mouse DNA sequence from clone . . . | 38 | 3.2 |

Unique and inferred unique genomic sequences can be identified using the method described herein for a number of other biological entities including, but not limited to; Anthrax (Bacillus anthracis), Botulism (Clostridium botulinum toxin), Brucellosis (Brucella species), Burkholderia mallei (glanders), Burkholderia pseudomallei (melioidosis), Chlamydia psittaci (psittacosis), Cholera (Vibrio cholerae), Clostridium perfringens (Epsilon toxin), Coxiella burnetii (Q fever), E. coli O157:H7 (Escherichia coli), Emerging infectious diseases such as Nipah virus and hantavirus, Food safety threats (e.g., Salmonella species, Escherichia coli O157:H7, Shigella), Francisella tularensis (tularemia), Ricin toxin from Ricinus communis (castor beans), Rickettsia prowazekii (typhus fever), Salmonella Typhi (typhoid fever), Salmonellosis (Salmonella species), Smallpox (variola major), Staphylococcal enterotoxin B, Variola major (smallpox), Viral encephalitis (alphaviruses e.g., Venezuelan equine encephalitis, eastern equine encephalitis, western equine encephalitis), Viral hemorrhagic fevers (filoviruses e.g., Ebola, Marburg and arenaviruses e.g., Lassa, Machupo), Yersinia pestis (plague).

Referring again to FIG. 1, unique genomic sequences were realigned 130 with the genome from which they were generated in order to determine the start and stop point of each fragment within the genome. In preferred embodiments, annotations within the genome in the region containing the unique sequence was transferred to the unique sequence. Annotated regions include sequences known to have a specific biological function such as protein coding regions, biologically active RNA encoding regions, promoter and regulatory elements, spacing elements within operons, protein binding sites, etc.

In some embodiments of the present invention, the process of obtaining genomic data, preprocessing the data, querying the selected database(s) and parsing results to identify candidate genomic sequences is implemented as a computer program product. In these embodiments, a plurality of organisms and sets of organisms can be investigated concurrently. Computer program products of this invention include the ability to indicate the organism(s)/set of organisms of interest, indicate the selected database, set thresholds for identifying inferred sequences, direct the handling for inferred sequences, set thresholds for identifying unique sequences, direct the handling for unique sequences, output unique sequences for evaluation for oligonucleotides amenable to hybridization. Intermediate and final results can be made available for user inspection. In preferred embodiments, such computer program products are in network communication, e.g., via the Internet with selected databases and databases of genomic data such as those available through NCBI via http://www.ncbi.nlm.nih.gov. Operator interface to such computer program products is preferably provided through graphical user interface (GUI) technologies as known to those skilled in the art. Such computer program products can be configured to operate in a centralized fashion or may be distributed over platforms on a network. Some embodiments are configured as an application service provider (ASP) accessible by network devices through a browser

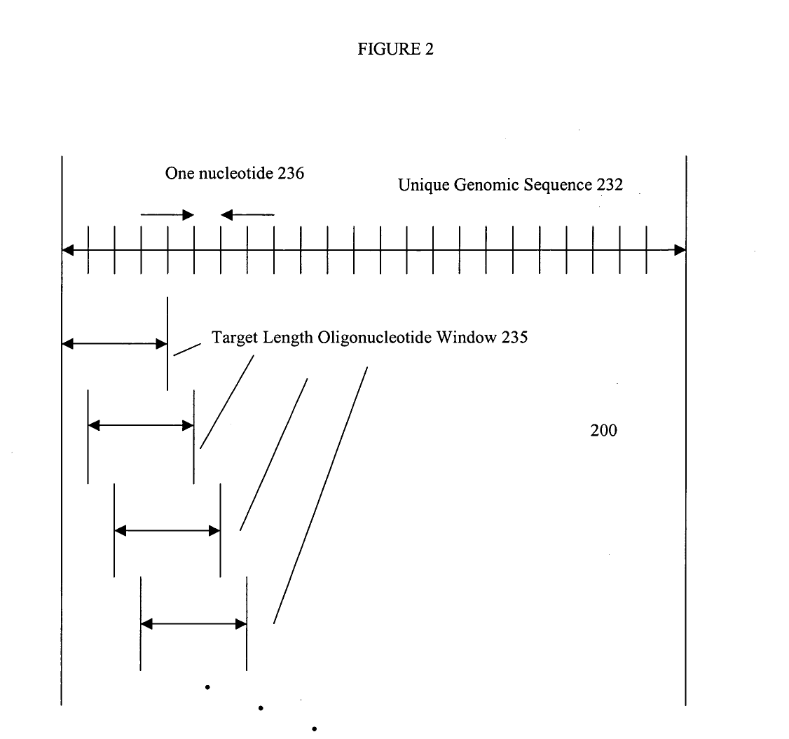

Both unique genomic sequences 132 and select inferred unique sequences 136 are evaluated 140 for subsets e.g., target-length oligonucleotides, that are amenable to hybridization. The evaluation is done in a target-length oligonucleotide window derived from the query length sequence, and preferably moved one base at a time through the query-length sequence. FIG. 2 presents a notional representation 200 of the incremental progression of a target-length oligonucleotide window 235 through a unique genomic sequence 232 one nucletotide 236 at a time. In preferred embodiments, the increment of progression is one nucleotide at a time, but in other embodiments different constant or variable progressions can be used to take advantage of the inherent properties of the unique genomic sequence. Target-length oligonucleotides are evaluated for, among other characteristics, GC content, metlting temperature (Tₘ), repetitive elements, availability of primer amplification sites, avoiding secondary structures such as hairpins and duplexes. In some embodiments this functionality is provided using a program such as OLIGO 6 (Molecular Biology Insights, Inc., Cascade Colo.). In other embodiments, this functionality is incorporated into a computer program product of the invention.

OLIGO is a multi-functional program that searches for and selects oligonucleotides from a sequence file for polymerase chain reaction (PCR), DNA sequencing, site-directed mutagenesis, and various hybridization applications. It calculates hybridization temperature and secondary structure of oligonucleotides based on the nearest neighbor thermodynamic values. It is also a good tool for construction of synthetic genes, finding an appropriate sequencing primer among those already synthesized, finding and multiplexing consensus primers and probes, and even finding potential restriction sites in a protein.

In preferred embodiments, oligonucleotides of approximately 50 bases in length are derived from the candidate sequences. A preferred range for oligonucletide lengths is 25-100 with a range of 50-70 being more preferred. Factors that go into determining a range and a preferred value include the ability to synthesize the oligonucletoide, the desired hybridization temperature of the microarray, balancing melting temperature of the various oligonucleotide against the GC content of the molecule and the possible chemical composition of the hybridization solution used on the microarray. As these factors change, the preferred length of oligonucleotides will also change. In some embodiments, target-length oligonucleotides are chosen based on their melting temperature Tₘ of 90 C, 3′-dimer AG of −8.0 kcal/mol, 3′-terminal stability range of −4.8 to 11.6 kcal/mol, GC clamp stability of −8.0 kcal/mol, minimal acceptable loop ΔG of −1.9 kcal/mol, maximum number of acceptable sequence repeats of 6 and a maximum length of acceptable dimmers of 2 base pairs. In practice, when prepared, oligonucleotides are dried and re-hydrated in 3×SSC (a solution of sodium chloride and sodium citrate) at a concentration of 150 ng/μl. These particular values are the defaults for OLIGO 6 calculations. They can be adjusted by the user based on the physical biochemistry of the particular acids. These are good general values for 50-mers at this temp and CG content.

In some embodiments, favorably evaluated target-length oligonucleotides 145, e.g., those found amenable to hybridization, are used as a query to a similarity search program 150, e.g., BLAST. The query is directed to a selected database 155 of genome data in order to determine whether the target-length oligonucleotide is unique to the organism or organism set under investigation. To this end, preferred embodiments parse 150 the similarity search program output to identify oligonucletoides lacking significant similarity with other organisms in the selected database, e.g., unique target-length oligonucleotides 152. This is counter to the typical use of such search programs. For the purpose of this disclosure, “unique” or “uniqueness” is a function of thresholds, preferably controlled by the user, regarding identity, homology, score, expected (E) value and the length of the unique sequence under consideration. Identity, score, expected value are data returned in a typical BLAST search. In some embodiments, lacking significant similarity, e.g., “unique,” means no BLAST hits or hits with a E-value less than 1e−5. In some embodiments, this determination of oligonucleotide uniqueness is conducted prior to evaluating the oligonucleotides for amenability to hybridization.

At this point, the certain oligonucleotides that can be identified as unique to the set for which they were searched. Such oligonucleotides have utility in confirming the presence of at least one member of the set in both Bioinformatic and “wet” settings. Table 4 lists exemplary set-unique oligonucleotides for E. coli K12 identified by a method of this invention. Table 5 is an exemplary BLAST search result showing the sufficient uniqueness of an oligonucleotide of E. coli 0157:h7. These oligonucletides, with optional annotation, can be saved to a database C38 of unique genomic sequence, or otherwise added to the growing knowledge base of the genome of the organism under investigation.

Referring again to FIG. 1, unique oligonucleotide sequences were realigned 160 with the genome from which they were generated in order to determine the start and stop point of each sequence within the genome. In preferred embodiments, annotations within the genome in the region containing the unique sequence was transferred to the unique sequence. Annotated regions include sequences known to have a specific biological function such as protein coding regions, biologically active RNA encoding regions, promoter and regulatory elements, spacing elements within operons, protein binding sites, etc.

TABLE 4

| | | |
|---|---|---|
| Oligo | | |
| Number | Organism | Seguence (5′ to 3′) |

E. coil K12
NC_000913_29_part354

| | |
|---|---|
| 91 | ACAGGATATAGTTATACCAGCGTTATTGTCGTTAGTGGTGAGTCGTCGGT |
| 92 | CAGTGATAATAACGTGACGCTGGATGGAAAGTTAACTGTTGTATCAGACA |
| 93 | TATAATCACAACGGTGAGCTTGTTATTACGGGTGATAATGCCACAGTAAA |
| 94 | AGAGGTAGAAACCACCACAGGTGAAAAGAAAAATACCAATGTGACTTGTC |
| 95 | TATCACAGAGGTAGAAACCACCACAGGTGAAAAGAAAAATACCAATGTGA |
| 96 | TTATACCAGCGTTATTGTCGTTAGTGGTGAGTCGTCGGTATATCTGAATG |
| 97 | TGAATATCACTGGTAACGTTCTGGTTGATAAGGATAAAACCGCAGACAAT |
| 98 | CAATACCGTTAATATGAATGGTGGACTTGAACTGATTGGAGAGAAAAACG |
| 99 | TTACGGCAGTGATAATAACGTGACGCTGGATGGAAAGTTAACTGTTGTAT |
| 100 | ATATTCGCCAGAAGGATTTATTATGCAAAGGAAAACTCTATTGTCGGCCT |
| 101 | GCAGATATCACAGAGGTAGAAACCACCACAGGTGAAAAGAAAAATACCAA |
| 102 | AGCGTTATTGTCGTTAGTGGTGAGTCGTCGGTATATCTGAATGGAGATAC |
| 103 | AAGAGCTTAAACGCTTACCCTCTGAATGCTCTCCTTTAGTCGAACAAAAC |
| 104 | GAAGTGGCAATATAATCACAACGGTGAGCTTGTTATTACGGGTGATAATG |
| 105 | CCGGCTTTCTTTATATTCGCCAGAAGGATTTATTATGCAAAGGAAAACTC |

TABLE 5

BLASTN 2.2.7 [Jan-02-2004]
RID: 1074620345-32204-105313520645.BLASTQ4
Query = (50 letters)
Database: All GenBank + EMBL + DDBJ + PDB sequences
(but no EST, STS, GSS, or phase 0, 1 or 2 HTGS sequences)
2,017,250 sequences; 9,771,119,756 total letters
Distribution of 110 Blast Hits on the Query Sequence

| | Score | E |
|---|---|---|
| Sequences producing significant alignments: | (bits) | Value |
| gi\|12519298\|gb\|AE005660.1\|AE005660 Escherichia coli O157: H7 . . . | 100 | 3e−19 |
| gi\|13364704\|dbj\|AP002569.1\| Escherichia coli O157: H7 DNA, c . . . | 100 | 3e−19 |
| gi\|262091\|gb\|S50878.1\|S50878 tyrosine hydroxylase {5′region . . . | 40 | 0.24 |
| gi\|24430266\|emb\|AL928973.3\| Mouse DNA sequence from clone R . . . | 38 | 0.95 |
| gi\|38083308\|ref\|XM_111684.3\| Mus musculus similar to corneo . . . | 36 | 3.8 |
| gi\|38083112\|ref\|XM_359287.1\| Mus musculus similar to corneo . . . | 36 | 3.8 |
| gi\|33286907\|gb\|BC055373.1\| Mus musculus cDNA clone MGC: 6076 . . . | 36 | 3.8 |
| gi\|18412479\|ref\|NM_106620.1\| Arabidopsis thaliana hypotheti . . . | 36 | 3.8 |

Just as set-unique genomic sequences and oligonucleotides can be identified for strains of a particular organisms (E. coli as above), the method can be used to identify genomic sequences and oligonucleotides unique to higher level sets such as species, genus, family, clade, ad hoc sets, etc.

Embodiments of the invention include both a method for profiling the hybridization response of set-unique target oligonucleotide sequences to a variety of organisms and sets of organisms and the resulting database of profiles. In these embodiments, target oligonucleotides are created in accordance with the unique sequences and are spotted to a microarray. Genomic DNA from each organism of interest is purified using procedures known to those skilled in the art. Preferably, the genomic DNA includes DNA from the area surrounding the region from which at least one target-length oligonucleotide was derived. In preferred embodiments, aliquots of the DNA are labeled, preferably with fluorescent dNTPs in a Klenow reaction. Each labeled DNA sample is allowed to hybridize with a microarray of the target-length oligonucleotides. The hybridized microarrays are wash, scanned, and the data is imported into a data visualization program (e.g., the suite of analysis software offered by Spotfire of Somerville Mass.). The data is evaluated to determine that target-length oligonucleotides exhibit true_positive and true_negative reactions to each organism of interest.

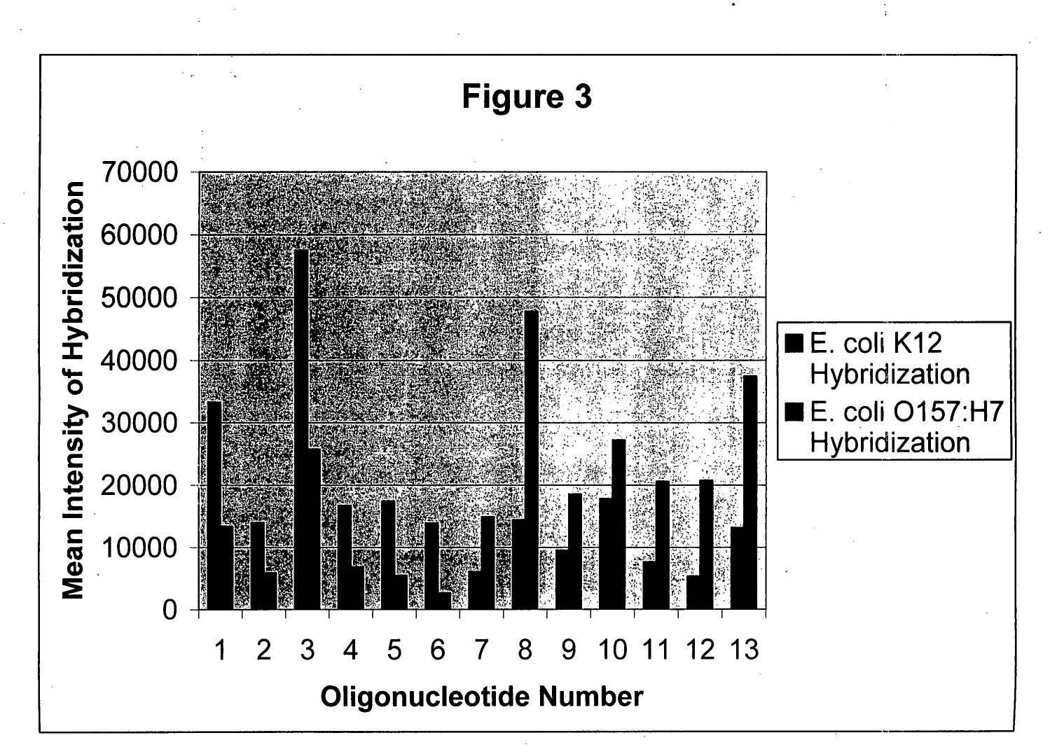

In practice, multiple copies of target-length oligonucleotides and multiple trials of hybridization are used for each organism of interest. In this fashion, data can be collected on the variation of hybridization intensity to be expected between each target-length oligonucleotide and each organism of interest. For example, statistics regarding the distribution of hybridization intensity between a target-length oligonucleotide and its corresponding organism can be collected. Table 6 presents a notional example of hybridization intensity for two organisms against oligonucleotides found to be unique to separate strains of E. coli and the E. coli Shiga gene. Table 6 identifies exemplary unique oligonucleotide sequences and provides the hybridization intensity for those sequences showing the greatest differential in hybridization intensity as between E. coli K12 and E. coli ol57:h7 based on the query-length sequences NC_{—}00913_{—}29_part354 and NC_{—}002695_{—}194_part29 respectively, along with Shiga gene oligonucleotide that exhibit differential hybridization intensity between the two E. coli strains. FIG. 3 illustrates this differential hybridization intensity between strains for oligonucleotides indicated by parenthetical numbers in Table 6.

TABLE 6

| | | | | |
|---|---|---|---|---|
| Oligo | | | K12 | O157:H7 |
| Number | Organism | Sequence 5′ to 3′ | Intensity | Intensity |

E. coli K12, NC_000913_29_part354

| | | | |
|---|---|---|---|
| (1) 91 | ACAGGATATAGTTATACCAGCGTTATTGTCGTTAGTGGTGAGTCGTCGGT | 33298 | 13380 |
| 92 | CAGTGATAATAACGTGACGCTGGATGGAAAGTTAACTGTTGTATCAGACA | | |
| (2) 93 | TATAATCACAACGGTGAGCTTGTTATTACGGGTGATAATGCCACAGTAAA | 13973 | 5880 |
| 94 | AGAGGTAGAAACCACCACAGGTGAAAAGAAAAATACCAATGTGACTTGTC | | |
| 95 | TATCACAGAGGTAGAAACCACCACAGGTGAAAAGAAAAATACCAATGTGA | | |
| (3) 96 | TTATACCAGCGTTATTGTCGTTAGTGGTGAGTCGTCGGTATATCTGAATG | 57432 | 25699 |
| 97 | TGAATATCACTGGTAACGTTCTGGTTGATAAGGATAAAACCGCAGACAAT | | |
| (4) 98 | CAATACCGTTAATATGAATGGTGGACTTGAACTGATTGGAGAGAAAAACG | 16711 | 6814 |
| 99 | TTACGGCAGTGATAATAACGTGACGCTGGATGGAAAGTTAACTGTTGTAT | | |
| (5) 100 | ATATTCGCCAGAAGGATTTATTATGCAAAGGAAAACTCTATTGTCGGCCT | 17384 | 5462 |
| 102 | AGCGTTATTGTCGTTAGTGGTGAGTCGTCGGTATATCTGAATGGAGATAC | | |
| (6) 104 | GAAGTGGCAATATAATCACAACGGTGAGCTTGTTATTACGGGTGATAATG | 13862 | 2643 |
| 105 | CCGGCTTTCTTTATATTCGCCAGAAGGATTTATTATGCAAAGGAAAACTC | | |

E. coli O157:h7, NC_002695_194_part29

| | | | |
|---|---|---|---|
| 278 | | | |
| 279 | ATTGTAAGGCGATTACTTTCTCAATCTTCTGAAATACGCAGTGCAAGTAG | | |
| 281 | TGTAAGGCGATTACTTTCTCAATCTTCTGAAATACGCAGTGCAAGTAGTC | | |
| 283 | TTAGGTCACACAATTCCAAAAGGCGGTTATGAACTTACTGAAGAACTTCC | | |
| 285 | CAATCTTCTGAAATACGCAGTGCAAGTAGTCTTCAGGTTGAAAGAATCTG | | |
| (7) 287 | GTTATGAACTTACTGAAGAACTTCCCTGGGTTTTTGAAGCGATGAATGAG | 6038 | 14850 |
| 288 | GTCCAATTCTGTTAGGTCACACAATTCCAAAAGGCGGTTATGAACTTACT | | |
| (8) 289 | GTAGTCTTCAGGTTGAAAGAATCTGGGTCGATGTTGATGACAGTTGGTAT | 14399 | 47725 |
| 292 | AAATCTCATTGTCGCTTCATGAAGGTCCAATTCTGTTAGGTCACACAATT | | |

E. coli Shiga Gene AF461172

| | | | |
|---|---|---|---|
| 296 | | | |
| 297 | CTGACTATCATGGACAAGACTCTGTTCGTGTAGGAAGAATTTCTTTTGGA | | |
| (9) 298 | AGGTACAACAGCGGTTACATTGTCTGGTGACAGTAGCTATACCACGTTAC | 9529 | 18509 |
| (10) 299 | GTGAGCTATACGGAAAGTACACAAAAAGGAAGGTGCGACCACAATTAATA | 17781 | 27191 |
| 300 | ATCGCCATTCGTTGACTACTTCTTATCTGGATTTAATGTCGCATAGTGGA | | |
| (11) 313 | CGGAAAGTACACAAAAAGGAAGGTGCGACCACAATTAATAACAAAATCTT | 7644 | 20573 |
| 314 | CGCTCTGCAATAGGTACTCCATTACAGACTATTTCATCAGGAGGTACGTC | | |
| 322 | ATTTACCAACAGATGGAATCTTCAGTCTCTTCTTCTCAGTGCGCAAATTA | | |
| 323 | AAGGAAGGTGCGACCACAATTAATAACAAAATCTTAAAAATTGCACATGG | | |
| (12) 324 | AATTATTTACCAACAGATGGAATCTTCAGTCTCTTCTTCTCAGTGCGCAA | 5319 | 20729 |
| (13) 325 | AAGTTATTTTTCGTTGACTCAGAATAGCTCAGTGAAAATAGCAGGCGGAG | 13167 | 37404 |

In one embodiment, the genomes of both E. coli K12 and E. coli O157:H7 were investigated to identify unique sequence. This search included queries such as the query-length sequence in Table 1. Sequence such as NC_{—}000913_{—}29_part354 (Table 1) and NC_{—}002695_{—}194_part29 and the E. coli Shiga Gene AF461172 were BLAST searched against the entire NCBI nt database to verify that these sequences are unique as defined with respect to embodiments of the invention, e.g,, see Table 2 for the E. coli K12 results. These results confirmed that the three query-length sequences noted directly above are unique. The query length sequences were used to generate oligonucleotides. A exemplary list of these oligonucleotides is presented in Table 4 for E. coli K12. The full set of oligonucleotides were BLAST searched against the NCBI nr database to verify that they were unique at the oligonucleotide level; Table 5 presents an exemplary extract of the BLAST output for an oligonucleotide of E. coli o157:57. Oligonucleotides confirmed unique for the set were manufactured and spotted to microarrays. The microarrays were hybridized with genomic probes manufactured by Klenow labeling genomic DNA with cy3-dCTP. Oligonucleotides that demonstrated differential hybridization patterns were detected; see Table 6 for exemplary values and FIG. 3 for a graphic representation. The thirteen oligonucleotides can now be used to distinguish between E. coli K12 and E. coli 0157:57.

In some embodiments, the invention leverages the principles illustrated by the previous example. In those embodiments, the database of hybridization profiles is used as one source to pick oligonucleotides that are informative at decision points in decision tree. Structures appropriate for the decision tree include most taxonomic hierarchies, but any hierarchy where some oligonucleotides at sibling decision points have discernable differential hybridization will work. Placement of redundant unique and conserved phylogenetic specific oligonucleotide targets permits the identification of sets of organisms (e.g., family, class, order, genus, species, strain) specific branch points that can be used to identify organisms. In addition, placement of targets can include those sensitive to other features such as virulence genes, structural genes, biochemical genes, antibiotic resistance genes, housekeeping genes,

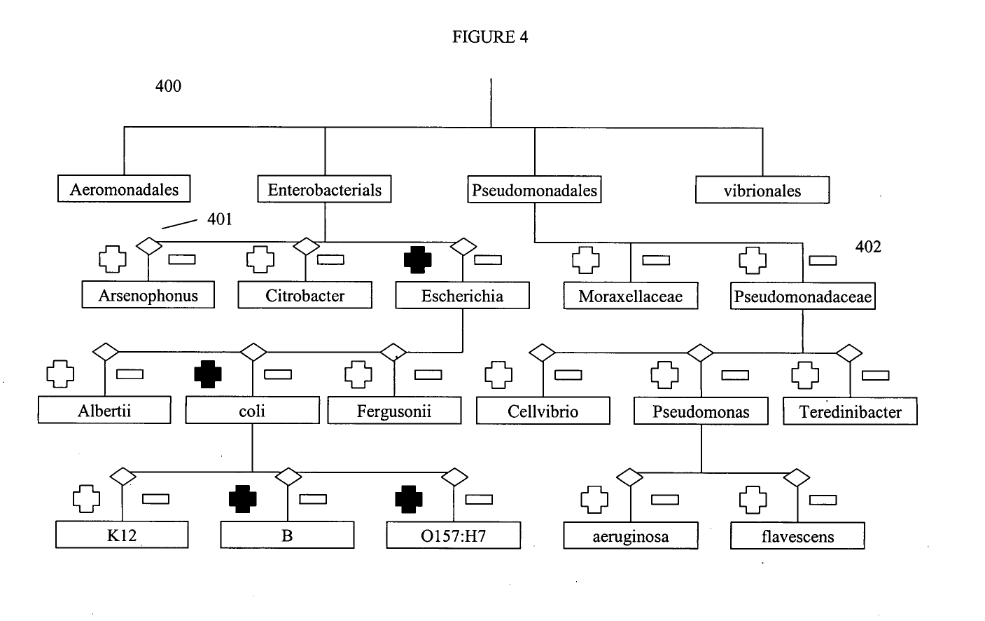

FIG. 4 illustrates a phylogenetic decision tree 400 in accordance with embodiments of the invention. In this particular embodiment, multiple oligonucleotide targets (including those from a database of unique oligonucleotides as described above that were found to provide useful differential hybridization between the organism sets under consideration) were spotted onto a microarray for each decision pint, e.g., 401 and exposed to a labeled complex sample for hybridization. Each decision point, e.g., 401 is scored with absent (−) or present (+) where:

$$Score = \frac{\sum A - {\sum }^{} B}{T}$$

A=number of (+) hybridized data points;
B=number of (−) hybridized data points; and
T=total data points.

In the embodiment illustrated in FIG. 4, decision points having a score above a threshold are indicated as present (+). In other embodiments, actual hybridization values are reported. In further embodiments, absent/present calls are either made on the basis of statistics for all hybridization points associated with the decision point. In yet other embodiments, the node with highest score is called “present” under a branch point.

In some embodiments, a confidence score is determined. In general each successive present call through the phylogenetic tree increases the confidence of the call below it and the confidence of the final identification. In FIG. 4, the presence of two present calls for two different strains of E. coli decreases the confidence of an accurate identification at the strain level but increases the confidence of the identification at the level of the species. In some embodiments, the confidence score for a decision point is determined based on Bayesian analysis methodologies where present calls in the correct lineage contribute to the confidence score for the final identification. Factors that increase the confidence of the final identification include present calls in the phylogenetic positions in the tier above the absent/present call and additional absent calls laterally within that tier. Also contributing to the confidence of the final identification is the presence of lateral absent calls within the same tier as the absent/present call. Thus the absent/present call at any one location in the phylogenetic tree is dependent on all of the absent/present calls in all tiers.

In some embodiments, the confidence score is represented as a numerical percentile between 0% and 100% by the following equation

$$Confidence\_score = \frac{( α - ρ )}{T} \times 100 ,$$

where
α=a+c+e, and
ρ=b+d+f, where
a=number of correct (+) calls in the correct lineage
b=number of incorrect (−) calls in the correct lineage;
c=number of correct (−) calls in the correct lineage;
d=number of incorrect (−) calls in the correct lineage;
e=number of correct (−) calls in the incorrect lineage; and
f=number of incorrect (+) calls in the incorrect lineage.

In some embodiments, a virulence score, a value used in conjunction with the final identification of the organism, is associated with the relative power and degree of pathogenicity of an organisms to produce disease. This value is derived from the number of virulence factors present, as detected by hybridization, compared to the total number of virulence factors represented in the array for a particular organism. Virulence targets can be spotted to the microarray independent of targets for absence/presence. This score is represented as a numerical value between −1 and +1 by the following equation:

$$Virulence\_score = \frac{\sum {V}_{A} - {\sum }^{} {V}_{B}}{{V}_{T}} ,$$

V_{A}=the number of (+) hybridized virulence-specific data points, and
V_{B}=the number of (−) hybridized virulence-specific data points.
V_{T}=the total number of virulence-specific targets associated with the decision point.

In addition, the ability to identify virulence versus structural components by oligonucleotide-specific hybridization permits the identification of recombinant organisms that contain structural components of one organism and the virulence components of a different organism. In some situations, a large number of data points may be required to identify all species and strains of micro organisms that might be found in a complex biological sample.

Some methods of the present invention are conducted to mitigate the effect of “noise” by pre-screening. In accordance with these methods, a background sample of interest is obtained, and nucleic acid sequences in the sample are amplified using random amplification and combined with a microarray for hybridization. Signals from amplification products that hybridize with the microarray are recorded to be discounted in subsequent analysis.

These methods are, for example, suited to customs applications. Customs officials at ports of entry including airports, harbors, and country borders can utilize prescreening to screen food samples for commonly occurring pathogens such as E. coli, Salmonella typhi, Hepatitis A virus and the like. In pathogen-free samples the level of hybridization observed to know pathogens on the array is minimal, the hybridization profile of such pathogen-free samples is then used as a baseline level to subsequently identify contaminated samples.

1. A method for identifying genomic sequences unique to a set of organisms, the method comprising:
obtaining genomic data characteristic of the set;
formatting the genomic data into at least one query-length sequence, each query-length sequence being of a format compatible with a similarity search engine;
searching a selected genomic database using the query and the similarity search engine; and
parsing the results of the search for those sequences showing uniqueness to the set.

2. The method of claim 1, wherein the similarity search engine is a BLAST search engine.

3. The method of claim 2, wherein the selected database is GenBank.

4. A computer program for identifying genomic sequences unique to a set of organisms, the computer program product comprising:
a computer-readable medium;
a genomic data interface module, stored on the medium and operable to couple to a source of genomic data to receive genomic data characteristic of the set;
a formatting module, stored on the medium and operable to format received genomic data into at least one query-length sequence, each query-length sequence being of a format compatible with a similarity search engine;
a search interface module, stored on the medium and operable to interface with the similarity search engine to submit the query-length sequence to the search engine
a search results parsing module, stored on the medium and operable to parse the results of the search for those sequences showing uniqueness to the set.

5. A method for identifying oligonucleotide sequences unique to a set of organisms, the method comprising:
obtaining genomic data characteristic of the set;
first formatting the genomic data into at least one query-length sequence, each query-length sequence being of a format compatible with a first similarity search engine;
first searching a first selected genomic database using the query-length sequence and the first similarity search engine;
first parsing the results of the first search for those genomic sequences showing uniqueness to the set;
dividing at least one genomic sequence showing uniqueness to the set into a plurality of target-length oligonucleotide sequences;
second formatting a plurality of the target oligonucleitide sequences into a query format compatible with a second similarity search engine;
second searching a second selected genomic database using the formatted target oligonucleotide sequences and the second similarity search engine;
second parsing the results of the second search for those oligonucleotides showing uniqueness to the set.

6. The method of claim 5, wherein:
the first and second similarity search engines are BLAST search engines.

7. The method of claim 5, wherein:
The selected database is GenBank.

8. A computer program for identifying oligonucleotide sequences unique to a set of organisms, the computer program product comprising:
a computer-readable medium;
a genomic data interface module, stored on the medium and operable to couple to a source of genomic data to receive genomic data characteristic of the set;
a first formatting module, stored on the medium and operable to format received genomic data into at least one query-length sequence, each query-length sequence being of a format compatible with a similarity search engine;
a first search interface module, stored on the medium and operable to interface with the similarity search engine to submit the query-length sequence to the search engine a first search results parsing module, stored on the medium and operable to parse the results of the search for those sequences showing uniqueness to the set.
dividing at least one genomic sequence showing uniqueness to the set into a plurality of target-length oligonucleotide sequences;
a second formatting module, stored on the medium and operable to format oligonucleotide sequences into a format compatible with a similarity search engine;
a second search interface module, stored on the medium and operable to interface with the similarity search engine to submit the formatted oligonucleotide sequence to the search engine; and
a second search results parsing module, stored on the medium and operable to parse the results of the search for those oligonucleotide sequences showing uniqueness to the set.

9. The computer program product of claim 8, wherein the first and second search modules are combined.

10. The computer program product of claim 8, wherein the first and second parsing modules are combined.

11. The computer program product of claim 8, wherein the first and second formatting modules are combined.

12. A method for inferring genomic sequences unique to a second set of organisms, the method comprising:
obtaining genomic data characteristic of a first set of organisms;
formatting the genomic data into at least one query-length sequence, each query-length sequence being of a format compatible with a similarity search engine;
searching a selected genomic database using the query and the similarity search engine;
parsing the results of the search for those sequences not associated with the first set of organisms, but showing similarity beyond a threshold.

13. A computer program for inferring genomic sequences unique to a second set of organisms, the computer program product comprising:
a computer-readable medium;
a genomic data interface module, stored on the medium and operable to couple to a source of genomic data to receive genomic data characteristic of a first set of organisms;
a formatting module, stored on the medium and operable to format received genomic data into at least one query-length sequence, each query-length sequence being of a format compatible with a similarity search engine;
a search interface module, stored on the medium and operable to interface with the similarity search engine to submit the query-length sequence to the search engine; and
a search results parsing module, stored on the medium and operable to parse the results of the search for those sequences not associated with the first set of organisms, but showing similarity beyond a threshold.


SEQUENCE LISTING (5 sequences)

SEQ ID NO: 1 - DNA, 1000 bp, Escherichia coli
tatgttttaaataactaattggtcgggttagtgcatccggctttctttatattcgccagaaggatttattatgcaaaggaaaactctattgtcggcctgtattgcattagctctgagtggtcagggttgggcggcagatatcacagaggtagaaaccaccacaggtgaaaagaaaaataccaatgtgacttgtccggcagacccaggaaaactcagtccggaagagcttaaacgcttaccctctgaatgctctcctttagtcgaacaaaacctgatgccatggctttccacaggcgctgctgcgttaatcacggccttagccgtagtggaactaaacgacgatgatgatcatcatcatcgcaacaattctccactcccaccgacaccccctgatgatgaatcagacgacactccagttcccccaactcctggcggagatgagataataccggacgatccggatgatacgcctacacctcccaaaccggtttcgtttaataatgacgttattctcgataaaacagaaaaaacgttaactattcgcgattcagtttttacttataccgagaatgctgacgggactatatctctgcaagatagcaatggtcgtaaggcaacgattaatctttggcagattgatgaagcgaataacactgttgcccttgaaggggtgagcgcagatggcgcaacgaagtggcaatataatcacaacggtgagcttgttattacgggtgataatgccacagtaaacaacaatggcaaaaccaccgttgacggtaaagattccaccggtacggaaatcaacggtaataacgggaaagtgattcaggacggcgatctggatgtcagcggcggcggtcacggtattgatatcaccggtgacagcgcgacggtggataacaagggcaccatgaccgtcaccgatccggagtccatgggtatccagatcgacggtgacaaggccatcgtcaataacgaaggcgagagcaccatcaccaac

SEQ ID NO: 2 - DNA, 750 bp, Escherichia coli
acaggatatagttataccagcgttattgtcgttagtggtgagtcgtcggtcagtgataataacgtgacgctggatggaaagttaactgttgtatcagacatataatcacaacggtgagcttgttattacgggtgataatgccacagtaaaagaggtagaaaccaccacaggtgaaaagaaaaataccaatgtgacttgtctatcacagaggtagaaaccaccacaggtgaaaagaaaaataccaatgtgattataccagcgttattgtcgttagtggtgagtcgtcggtatatctgaatgtgaatatcactggtaacgttctggttgataaggataaaaccgcagacaatcaataccgttaatatgaatggtggacttgaactgattggagagaaaaacgttacggcagtgataataacgtgacgctggatggaaagttaactgttgtatatattcgccagaaggatttattatgcaaaggaaaactctattgtcggcctgcagatatcacagaggtagaaaccaccacaggtgaaaagaaaaataccaaagcgttattgtcgttagtggtgagtcgtcggtatatctgaatggagatacaagagcttaaacgcttaccctctgaatgctctcctttagtcgaacaaaacgaagtggcaatataatcacaacggtgagcttgttattacgggtgataatgccggctttctttatattcgccagaaggatttattatgcaaaggaaaactc

SEQ ID NO: 3 - DNA, 650 bp, Escherichia coli
acaggatatagttataccagcgttattgtcgttagtggtgagtcgtcggtcagtgataataacgtgacgctggatggaaagttaactgttgtatcagacatataatcacaacggtgagcttgttattacgggtgataatgccacagtaaaagaggtagaaaccaccacaggtgaaaagaaaaataccaatgtgacttgtctatcacagaggtagaaaccaccacaggtgaaaagaaaaataccaatgtgattataccagcgttattgtcgttagtggtgagtcgtcggtatatctgaatgtgaatatcactggtaacgttctggttgataaggataaaaccgcagacaatcaataccgttaatatgaatggtggacttgaactgattggagagaaaaacgttacggcagtgataataacgtgacgctggatggaaagttaactgttgtatatattcgccagaaggatttattatgcaaaggaaaactctattgtcggcctagcgttattgtcgttagtggtgagtcgtcggtatatctgaatggagatacgaagtggcaatataatcacaacggtgagcttgttattacgggtgataatgccggctttctttatattcgccagaaggatttattatgcaaaggaaaactc

SEQ ID NO: 4 - DNA, 400 bp, Escherichia coli
attgtaaggcgattactttctcaatcttctgaaatacgcagtgcaagtagtgtaaggcgattactttctcaatcttctgaaatacgcagtgcaagtagtcttaggtcacacaattccaaaaggcggttatgaacttactgaagaacttcccaatcttctgaaatacgcagtgcaagtagtcttcaggttgaaagaatctggttatgaacttactgaagaacttccctgggtttttgaagcgatgaatgaggtccaattctgttaggtcacacaattccaaaaggcggttatgaacttactgtagtcttcaggttgaaagaatctgggtcgatgttgatgacagttggtataaatctcattgtcgcttcatgaaggtccaattctgttaggtcacacaatt

SEQ ID NO: 5 - DNA, 500 bp, Escherichia coli
ctgactatcatggacaagactctgttcgtgtaggaagaatttcttttggaaggtacaacagcggttacattgtctggtgacagtagctataccacgttacgtgagctatacggaaagtacacaaaaaggaaggtgcgaccacaattaataatcgccattcgttgactacttcttatctggatttaatgtcgcatagtggacggaaagtacacaaaaaggaaggtgcgaccacaattaataacaaaatcttcgctctgcaataggtactccattacagactatttcatcaggaggtacgtcatttaccaacagatggaatcttcagtctcttcttctcagtgcgcaaattaaaggaaggtgcgaccacaattaataacaaaatcttaaaaattgcacatggaattatttaccaacagatggaatcttcagtctcttcttctcagtgcgcaaaagttatttttcgttgactcagaatagctcagtgaaaatagcaggcggag